(19) United States
(12) Patent Application Publication
(10) Pub. No.: US 2016/0218817 A1
(43) Pub. Date: Jul. 28, 2016

(54) INFORMATION DISTRIBUTION SYSTEM, INFORMATION DISTRIBUTION APPARATUS, AND INFORMATION DISTRIBUTION METHOD

(71) Applicants: Yasuyuki NAKAMURA, Tochigi (JP); Tsutomu KAWASE, Kanagawa (JP); Fumihiko ITOH, Kanagawa (JP); Michiaki SHINOTSUKA, Kanagawa (JP)

(72) Inventors: Yasuyuki NAKAMURA, Tochigi (JP); Tsutomu KAWASE, Kanagawa (JP); Fumihiko ITOH, Kanagawa (JP); Michiaki SHINOTSUKA, Kanagawa (JP)

(21) Appl. No.: 15/003,870

(22) Filed: Jan. 22, 2016

(30) Foreign Application Priority Data
Jan. 26, 2015 (JP) 2015-012234

(51) Int. Cl. H04H 60/52; H04H 60/58; H04H 60/63; G01S 3/801

(52) U.S. Cl. CPC H04H 60/52; G01S 3/801; H04H 60/58; H04H 60/63

(57) ABSTRACT

An information distribution system includes an information distribution apparatus, a sound wave generator that outputs a sound wave including first identification information, and a terminal that transmits an information distribution request. The information distribution apparatus includes a determining unit and a distribution control unit. When a distance between a location of the sound wave generator identified from the first identification information included in a first information distribution request received at a first time and a location of the sound wave generator identified from the first identification information included in a second information distribution request received at a second time prior to the first time is a threshold or less, the determining unit determines that the second identification information included in the first information distribution request is valid. When the first identification information is valid, the distribution control unit distributes distribution information associated with the first identification information to the terminal.

### CROSS-REFERENCE TO RELATED APPLICATIONS

The present application claims priority to and incorporates by reference the entire contents of Japanese Patent Application No. 2015-012234 filed in Japan on Jan. 26, 2015.

### BACKGROUND OF THE INVENTION

1. Field of the Invention

The present invention relates to an information distribution system, an information distribution apparatus, and an information distribution method.

2. Description of the Related Art

In recent years, services using location information have attracted attention. A technology for transmitting information using a sound wave has been conventionally known. For example, a technology is known, in which, when a terminal such as a smart device receives the sound wave output from a speaker installed in a store, the terminal acquires information for specials offered by the store, information for coupons, or the like from a server device.

However, there is a problem that location identification information for identifying the location of a terminal can be spoofed by collecting a recorded sound wave in the terminal.

### SUMMARY OF THE INVENTION

It is an object of the present invention to at least partially solve the problems in the conventional technology.

According to an embodiment, an information distribution system includes an information distribution apparatus, a sound wave generator, and a terminal. The sound wave generator includes an output unit configured to output a sound wave including first identification information for identifying the sound wave generator. The terminal includes a sound collecting unit and a first communication unit. The sound collecting unit collects the sound wave output from the sound wave generator. The first communication unit transmits an information distribution request that includes second identification information for identifying the terminal and the first identification information included in the sound wave to the information distribution apparatus. The information distribution apparatus includes a second communication unit, a determining unit, and a distribution control unit. The second communication unit receives the information distribution request from the terminal. When a distance between a location of the sound wave generator identified from the first identification information included in a first information distribution request received at a first time and a location of the sound wave generator identified from the first identification information included in a second information distribution request received at a second time prior to the first time is equal to or less than a threshold, the determining unit determines that the second identification information included in the first information distribution request is valid. When the first identification information is valid, the distribution control unit distributes distribution information associated with the first identification information to the terminal which has transmitted the information distribution request.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of a configuration example of an information distribution system according to an embodiment;

FIG. 2 is a diagram of a configuration example of an information distribution apparatus according to the embodiment;

FIG. 3 is a diagram of an example of a speaker ID according to the embodiment;

FIG. 4 is a diagram of a configuration example of a speaker according to the embodiment;

FIG. 5 is a diagram of a configuration example of a terminal according to the embodiment;

FIG. 6 is a flowchart of an example of how the information distribution apparatus according to the embodiment transmits a speaker ID;

FIG. 7 is a flowchart of an example of how the speaker according to the embodiment outputs a sound wave;

FIG. 8 is a sequence diagram of an example of an information distribution method according to the embodiment;

FIG. 9 is a diagram of an example of a hardware configuration of the information distribution apparatus according to the embodiment; and

FIG. 10 is a diagram of an example of a hardware configuration of the terminal according to the embodiment.

### DETAILED DESCRIPTION OF THE PREFERRED EMBODIMENTS

Exemplary embodiments of an information distribution system, an information distribution apparatus, and an information distribution method will be explained in detail below with reference to the accompanying drawings.

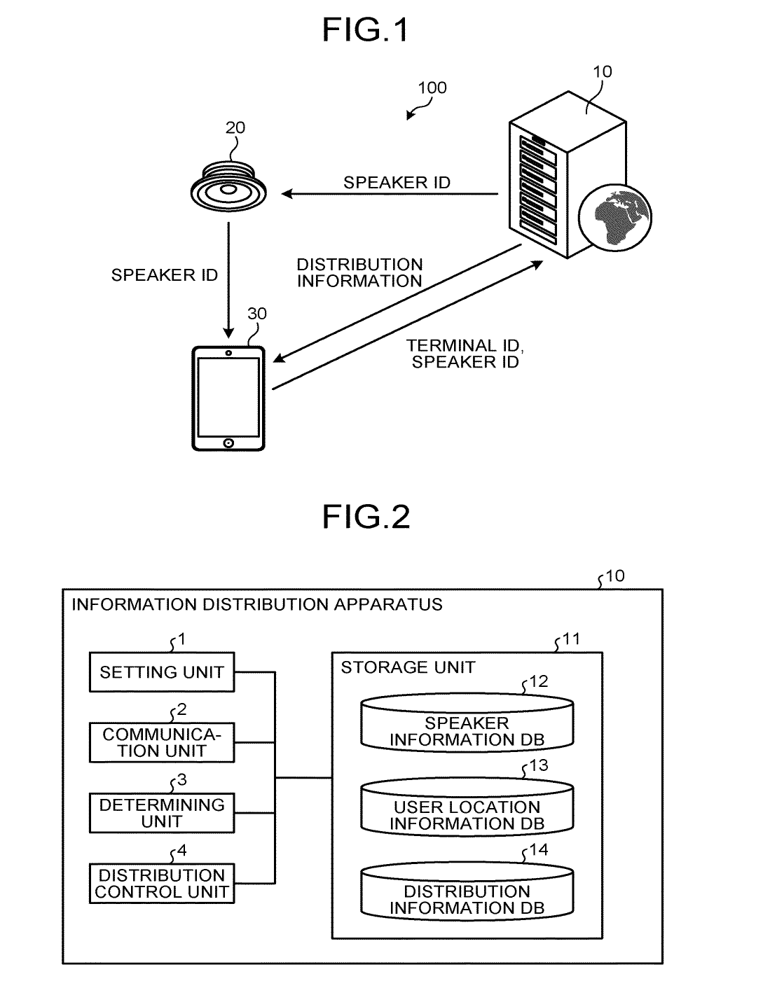

FIG. 1 is a diagram of a configuration example of an information distribution system 100 according to an embodiment. The information distribution system 100 according to the embodiment includes an information distribution apparatus 10, a speaker 20, and a terminal 30. The information distribution apparatus 10 transmits a speaker ID (which corresponds to first identification information) for identifying the speaker 20 to the speaker 20. The speaker 20 (which corresponds to a sound wave generator) outputs a sound wave including the speaker ID. The terminal 30 collects the sound wave output from the speaker and transmits an information distribution. The information distribution request includes a terminal ID (which corresponds to second identification information) for identifying the terminal 30 and the speaker ID included in the sound wave to the information distribution apparatus 10. When receiving the information distribution request from the terminal 30, if the speaker ID included in the information distribution request is a valid speaker ID, the information distribution apparatus 10 distributes distribution information associated with the speaker ID to the terminal 30. In other words, the speaker ID is used as location identification information for identifying the location of a user of the terminal 30.

The operations of the information distribution apparatus 10, the speaker 20, and the terminal 30 are specifically explained below.

FIG. 2 is a diagram of a configuration example of the information distribution apparatus 10 according to the embodiment. The information distribution apparatus 10 according to the embodiment includes a setting unit 1, a communication unit 2, a determining unit 3, and a distribution control unit 4. A storage unit 11 stores therein a speaker information database (DB) 12, a user location information DB 13, and a distribution information DB 14.

Transmission Operation of Speaker ID

An example of transmission operation of the speaker ID will be explained first. The setting unit 1 creates the speaker information DB 12. Table 1 represents an example of the speaker information DB 12 created by the setting unit 1 at time T1.

TABLE 1

| | | Facility | | Speaker ID |
|---|---|---|---|---|
| Area | Facility | Number | Location | (Time T1) |
| Tokyo | Supermarket A | 1 | a1 | SP000001 |
| Tokyo | Supermarket A | 1 | a2 | SP000002 |
| Tokyo | Supermarket A | 1 | a3 | SP000003 |
| Tokyo | Supermarket A | 1 | a4 | SP000004 |
| Tokyo | Supermarket A | 1 | a5 | SP000005 |
| Tokyo | Supermarket A | 1 | a6 | SP000006 |
| Tokyo | Supermarket A | 1 | a7 | SP000007 |
| Tokyo | Supermarket A | 1 | a8 | SP000008 |
| Tokyo | Supermarket A | 1 | a9 | SP000009 |

The speaker information DB 12 includes Area, Facility, Facility Number, Location, and Speaker ID. Area indicates an area where the speaker 20 is installed. Facility indicates a facility where the speaker 20 is installed. Facility Number is a number that identifies the facility. Location indicates a location of the speaker 20 installed in the facility. Speaker ID is identification information for identifying the speaker 20.

The communication unit 2 transmits a speaker ID in the speaker information DB 12 to the speaker 20. For example, SP000001 is transmitted to the speaker 20 installed at a position a1 in a supermarket A.

The setting unit 1 periodically updates speaker IDs in the speaker information DB 12. The setting unit 1 adds a newly set speaker ID to the speaker information DB 12. Table 2 represents an example in which a speaker ID created at time T2 is added to the speaker information DB 12 of Table 1.

TABLE 2

| | | | | Speaker | Speaker |
|---|---|---|---|---|---|
| | | | | ID | ID |
| | | Facility | | (Time | (Time |
| Area | Facility | Number | Location | T1) | T2) |
| Tokyo | Supermarket A | 1 | a1 | SP000001 | SP100002 |
| Tokyo | Supermarket A | 1 | a2 | SP000002 | SP200003 |
| Tokyo | Supermarket A | 1 | a3 | SP000003 | SP300004 |
| Tokyo | Supermarket A | 1 | a4 | SP000004 | SP400005 |
| Tokyo | Supermarket A | 1 | a5 | SP000005 | SP500006 |
| Tokyo | Supermarket A | 1 | a6 | SP000006 | SP600007 |
| Tokyo | Supermarket A | 1 | a7 | SP000007 | SP700008 |
| Tokyo | Supermarket A | 1 | a8 | SP000008 | SP800009 |
| Tokyo | Supermarket A | 1 | a9 | SP000009 | SP000001 |

When a speaker ID is newly set in the speaker information DB 12, the communication unit 2 transmits the newly set speaker ID to the speaker 20. For example, SP100002 is transmitted to the speaker 20 installed at the position a1 in the supermarket A. Thereby, the speaker ID of the speaker 20 installed at the position a1 in the supermarket A is updated from SP000001 to SP100002. The communication unit 2 periodically transmits the speaker ID to the speaker 20, and this enables the confidentiality of the speaker ID to be improved.

In setting the speaker ID, the setting unit 1 sets so as not to overlap at each set time.

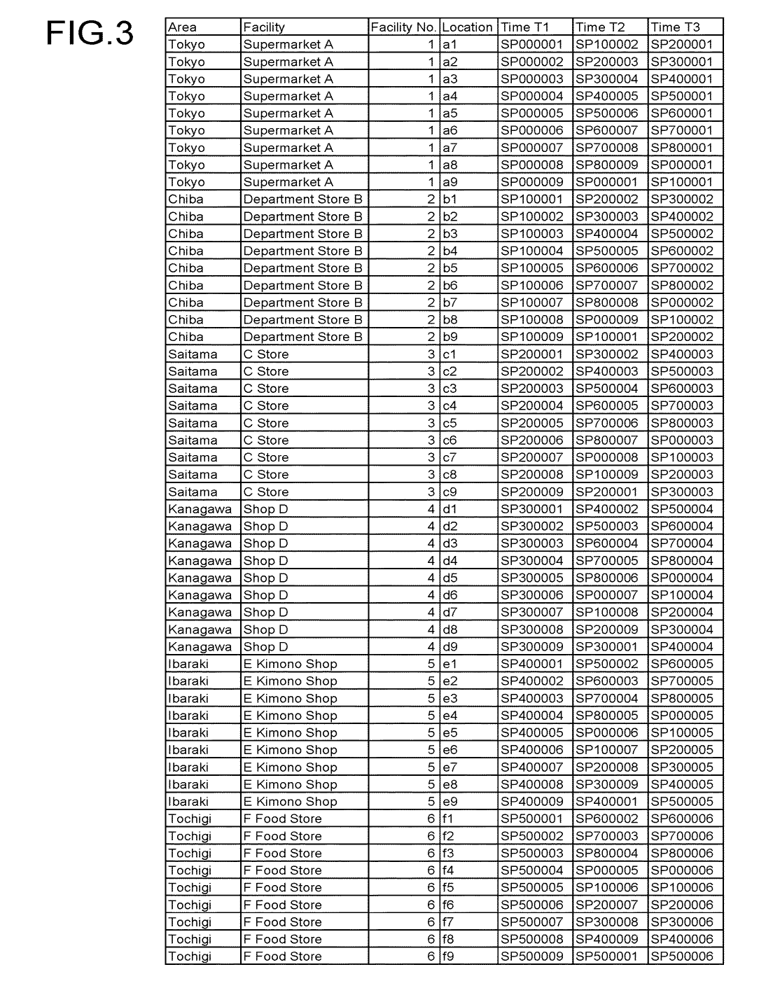

FIG. 3 is a diagram of an example of the speaker ID according to the embodiment. FIG. 3 represents examples of speaker IDs set at time T1, time T2, and time T3. As illustrated in FIG. 3, the speaker IDs are set by the setting unit 1 so as not to overlap each other at each set time.

Distribution Operation of Distribution Information

An example of distribution operation of distribution information will be explained next. When the terminal 30 collects the sound wave including the speaker ID from the speaker 20, the communication unit 2 receives an information distribution request including the terminal ID for identifying the terminal 30 and the speaker ID from the terminal 30. Table 3 represents an example of the information distribution request.

TABLE 3

| Terminal ID | Speaker ID |
|---|---|
| 123456789 | SP100002 |

The communication unit 2 inputs the terminal ID and the speaker ID included in the information distribution request to the determining unit 3. When receiving the terminal ID and the speaker ID from the communication unit 2, the determining unit 3 adds a record to the user location information DB 13. Table 4 represents an example of the record to be added to the user location information DB 13.

TABLE 4

| Terminal | Speaker | Receipt | | | Facility | |
|---|---|---|---|---|---|---|
| ID | ID | Time | Area | Facility | Number | Location |
| 123456789 | SP100002 | 2014/2/10/11:14 | Tokyo | Supermarket | 1 | a1 |
| | | | | A | | |

The user location information DB 13 includes Terminal ID, Speaker ID, Receipt Time, Area, Facility, Facility Number, and Location. Terminal ID is identification information for identifying the terminal. Speaker ID is identification information for identifying the speaker 20. Receipt Time is a time at which the information distribution apparatus 10 receives the information distribution request from the terminal 30. Area indicates the area where the speaker 20 is installed. Facility indicates the facility where the speaker 20 is installed. Facility Number is a number that identifies the facility. Location indicates the location of the speaker 20 installed in the facility.

The determining unit 3 sets the terminal ID and the speaker ID received from the communication unit 2 as Terminal ID and Speaker ID of the record to be added to the user location information DB 13. The determining unit 3 sets the current time, which is a time at which the information distribution apparatus 10 receives the information distribution request, as Receipt Time of the record to be added to the user location information DB 13. The determining unit 3 searches a column of Speaker ID of the speaker information DB 12 using the speaker ID received from the communication unit 2 as a search key. When there is a plurality of columns of Speaker ID in the speaker information DB 12, the determining unit 3 searches a column of Speaker ID whose set time is the latest. The determining unit 3 sets the area, the facility, the facility number, and the location of the retrieved record, as Area, Facility, Facility Number, and Location of the record to be added to the user location information DB 13.

Then the determining unit 3 determines whether the speaker ID received from the communication unit 2 is the valid speaker ID. Specifically, among records of the user location information DB 13 having the terminal ID received from the communication unit 2, the determining unit 3 retrieves a record in which a value of Receipt time is within a predetermined time period (e.g., 10 minutes) before the current time.

Table 5 represents an example of the retrieval results from the user location information DB 13.

TABLE 5

| Terminal | Speaker | Receipt | | | Facility | |
|---|---|---|---|---|---|---|
| ID | ID | Time | Area | Facility | Number | Location |
| 123456789 | SP200003 | 2014/2/10/11:10 | Tokyo | Supermarket | 1 | a2 |
| | | | | A | | |
| 123456789 | SP100002 | 2014/2/10/11:14 | Tokyo | Supermarket | 1 | a1 |
| | | | | A | | |

In the case of the retrieval results of Table 5, the record corresponding to the speaker 20 at the location a2 of the supermarket A is retrieved in addition to a newly added record (see Table 4). Thus, the determining unit 3 determines that the speaker ID received from the communication unit 2 is the valid speaker ID.

In other words, when a distance between the location of the speaker 20 identified from the speaker ID included in the information distribution request and the location of another speaker 20 identified from a speaker ID included in another information distribution request received within a predetermined time period (e.g., 10 minutes) before a receipt time, at which the information distribution request is received, is equal to or less than a threshold (e.g., 500 m), the determining unit 3 determines that the speaker ID included in an information distribution request is the valid speaker ID.

The predetermined time period and the threshold may be arbitrarily determined according to a moving speed of the user of the terminal 30, or the like. For example, when a plurality of speakers 20 are installed in the same shop, the predetermined time period and the threshold may be determined according to each interval between the speakers 20, the moving speed of the user, or the like. Moreover, for example, when the speaker 20 is installed in a plurality of facilities one by one and the user is assumed to visit the facilities using transportation such as an automobile and a train, the predetermined time period and the threshold may be determined according to each distance between the facilities and the speed of the transportation, etc.

When there is no record to be compared as a result of searching the user location information DB 13, the determining unit 3 determines whether the location information of the user using a Global Positioning system (GPS) can be used. The determination operation of the location information using GPS will be explained later.

When the speaker ID included in the information distribution request is invalid, the determining unit 3 deletes the record (see Table 4) in the user location information DB 13 created in response to the information distribution request.

When the speaker ID included in the information distribution request is valid, the distribution control unit 4 distributes the distribution information according to the information distribution request to the terminal 30. Specifically, the distribution control unit 4 acquires the distribution information from the distribution information DB 14. Table 6 represents an example of the distribution information DB 14.

TABLE 6

| | | Facility | | Distribution | Combination | GPS |
|---|---|---|---|---|---|---|
| Area | Facility | Number | Location | Information | with GPS | Information |
| Tokyo | Supermarket | 1 | a2 | Coupon | NO | |
| | A | | | | | |
| Ciba | Department | 2 | b2 | Coupon | NO | |
| | Store | | | | | |
| | B | | | | | |
| Saitama | C Store | 3 | c3 | Coupon | NO | |
| Kanagawa | Shop D | 4 | d3 | Coupon | NO | |
| Ibaraki | E Kimono | 5 | e5 | Information | NO | |
| | shop | | | | | |
| Tochigi | F Food | 6 | f9 | New Product | NO | |
| | Store | | | Information | | |
| Gunma | G | 7 | g7 | Coupon | NO | |
| | Optician | | | | | |
| Fukushima | Hotel H | 8 | h1 | Gift | YES | XXXXX |
| | | | | Information | | YYYYY |
| Miyagi | Hobby I | 9 | i10 | New Product | NO | |
| | | | | Information | | |

The distribution information DB 14 includes Area, Facility, Facility Number, Location, Distribution Information, Combination with GPS, and GPS Information. Area indicates an area where the speaker 20 is installed. Facility indicates a facility where the speaker 20 is installed. Facility Number is a number that identifies the facility. Location indicates a location of the speaker 20 installed in the facility. Distribution Information indicates information to be distributed to the terminal 30. Combination with GPS indicates the propriety of the combination with GPS. When the combination with GPS is set to NO, this means a case where an allowable range (positioning error) of GPS is larger than, for example, an interval between the speakers 20. GPS Information indicates the location where the speaker 20 is installed. GPS Information is not set in the record in which the combination with GPS is set to NO.

The distribution control unit 4 searches the speaker information DB 12 using the speaker ID included in an information distribution request as a search key. The distribution control unit 4 then acquires the area, the facility, the facility number, and the location from the retrieved record. The distribution control unit 4 searches the distribution information DB 14 using the area, the facility, the facility number, and the location as search keys. Then, the distribution control unit 4 acquires distribution information from the retrieved record, and inputs the distribution information to the communication unit 2.

When receiving the distribution information from the distribution control unit 4, the communication unit 2 transmits the distribution information to the terminal 30 which has transmitted the information distribution request.

It has been explained above how the distribution control unit 4 performs the operation of acquiring the distribution information from the distribution information DB 14 when the determining unit 3 determines that the speaker ID included in the information distribution request is valid. Alternatively, the distribution control unit 4 may first determine whether there is corresponding distribution information in the distribution information DB 14, and then, when there is the distribution information, the determining unit 3 may determine the validity of the speaker ID.

Example of when Invalid Speaker ID is Received

An example of a case in which the information distribution apparatus 10 receives an information distribution request including an invalid speaker ID from the terminal 30 will be explained next. The speaker information DB 12 is assumed to be in the state illustrated in Table 7.

TABLE 7

| | | Facility | | Speaker ID |
|---|---|---|---|---|
| Area | Facility | Number | Location | (Time T1) |
| Tokyo | Supermarket A | 1 | a1 | SP000001 |
| Tokyo | Supermarket A | 1 | a2 | SP000002 |
| Tokyo | Supermarket A | 1 | a3 | SP000003 |
| Tokyo | Supermarket A | 1 | a4 | SP000004 |
| Tokyo | Supermarket A | 1 | a5 | SP000005 |
| Chiba | Department | 2 | b1 | SP100001 |
| | Store B | | | |
| Chiba | Department | 2 | b2 | SP100002 |
| | Store B | | | |
| Chiba | Department | 2 | b3 | SP100003 |
| | Store B | | | |
| Chiba | Department | 2 | b4 | SP100004 |
| | Store B | | | |

It is assumed that a malicious user moves from near the speaker 20 at the location b1 of the department store B to near the speaker 20 at the location b2 of the department store B and then replays the previously recorded sound wave including the speaker ID (SP000002) using the terminal 30. In this case, the terminal 30 collects the sound wave including a speaker ID (SP100001) near the speaker 20 at the location b1 of the department store B and transmits an information distribution request including the speaker ID (SP100001) to the information distribution apparatus 10. Then the terminal 30 collects the sound wave including a speaker ID (SP100002) near the speaker 20 at the location b2 of the department store B and transmits an information distribution request including the speaker ID (SP100002) to the information distribution apparatus 10. The terminal 30 then collects the previously recorded sound wave including the speaker ID (SP000002) and transmits an information distribution request including the speaker ID (SP000002) to the information distribution apparatus 10.

At this time, the determining unit 3 of the information distribution apparatus 10 determines that a distance between the location of the speaker 20 (location a2 of the supermarket A in Tokyo) identified from the speaker ID (SP000002) and the location of another speaker (location b2 of the department store B in Chiba) identified from the speaker ID (SP100002) included in another information distribution request received within a predetermined time period (e.g., 10 minutes) before a receipt time, at which the information distribution request including the speaker ID (SP000002) is received, is larger than a threshold (e.g., 500 m). In other words, the information distribution apparatus 10 determines that the user moves a long distance from Tokyo (Supermarket A) to Chiba (Department store B) within a short period of time (e.g., 10 minutes), and thereby specifies that the speaker ID (SP000002) is invalid.

When Used in Combination with GPS Information

A case in which the information distribution apparatus 10 identifies the location of the terminal 30 using in combination with GPS will be explained next. For example, when only one speaker 20 is installed within the same facility, the information distribution apparatus 10 cannot always acquire a plurality of speaker IDs within the predetermined time period (e.g., 10 minutes). In this case, the information distribution apparatus 10 determines the validity of the speaker ID included in the information distribution request transmitted from the terminal 30 using in combination with the GPS Information.

When the terminal 30 corrects the sound wave including a speaker ID from the speaker 20, the communication unit 2 receives an information distribution request including the terminal ID for identifying the terminal 30 and the speaker ID from the terminal 30. Table 8 represents an example of the information distribution request.

TABLE 8

| Terminal ID | Speaker ID |
|---|---|
| 123456789 | SP800002 |

The communication unit 2 inputs the terminal ID and the speaker ID included in the information distribution request to the determining unit 3. When receiving the terminal ID and the speaker ID from the communication unit 2, the determining unit 3 adds a record to the user location information DB 13. Table 9 represents an example of the record to be added to the user location information DB 13.

TABLE 9

| Terminal | Speaker | Receipt | | | Facility | |
|---|---|---|---|---|---|---|
| ID | ID | Time | Area | Facility | Number | Location |
| 123456789 | SP800002 | 2014/3/15/17:14 | Fukushima | Hotel | 8 | h1 |
| | | | | H | | |

The determining unit 3 sets the terminal ID and the speaker ID received from the communication unit 2 as Terminal ID and Speaker ID of the record to be added to the user location information DB 13. The determining unit 3 also sets the current time, which is a time at which the information distribution apparatus 10 receives the information distribution request, as Receipt Time of the record to be added to the user location information DB 13. The determining unit 3 searches a column of Speaker ID in the speaker information DB 12 using the speaker ID received from the communication unit 2 as a search key. When there is a plurality of columns of Speaker ID in the speaker information DB 12, the determining unit 3 searches a column of Speaker ID whose set time is the latest. The determining unit 3 sets the area, the facility, the facility number, and the location in the retrieved record as Area, Facility, Facility Number, and Location in the user location information DB 13.

Then the determining unit 3 determines whether the speaker ID received from the communication unit 2 is a valid speaker ID. Specifically, among records of the user location information DB 13 having the terminal ID received from the communication unit 2, the determining unit 3 retrieves a record in which a value of Receipt time is within a predetermined time period (e.g., 10 minutes) before the current time. Table 10 represents a retrieval result from the user location information DB 13.

TABLE 10

| Terminal | Speaker | Receipt | | | Facility | |
|---|---|---|---|---|---|---|
| ID | ID | Time | Area | Facility | Number | Location |
| 123456789 | SP800002 | 2014/3/15/17:14 | Fukushima | Hotel | 8 | h1 |
| | | | | H | | |

In the case of the retrieval result of Table 10, any record other than the newly added record illustrated in Table 10 is not retrieved. Thus, the determining unit 3 then determines whether the location information for the terminal 30 of the user obtained by using GPS can be used. Specifically, the determining unit 3 searches the speaker information DB 12 using the speaker ID included in the information distribution request as a search key. The determining unit 3 then acquires the area, the facility, the facility number, and the location from the retrieved record. The determining unit 3 searches the distribution information DB 14 using the area, the facility, the facility number, and the location as search keys. Table 11 represents an example of a retrieval result from the distribution information DB 14.

TABLE 11

| | | Facility | | Distribution | Combination | GPS |
|---|---|---|---|---|---|---|
| Area | Facility | Number | Location | Information | with GPS | Information |
| Fukushima | Hotel H | 8 | h1 | Gift | YES | XXXXX |
| | | | | Information | | YYYYY |

In the example of the retrieval result of Table 11, because the combination with GPS is YES, the determining unit 3 inputs a GPS information acquisition request, as an acquisition request of location information for the terminal 30, to the communication unit 2. The determining unit 3 receives a response to the GPS information acquisition request from the terminal 30 through the communication unit 2. The determining unit 3 determines that the speaker ID included in the information distribution request is the valid speaker ID when a distance between the location indicated by the GPS Information included in the response and the location indicated by the GPS Information (see Table 11) in the record of the distribution information DB 14 is equal to or less than the threshold (e.g., 500 m).

When the speaker ID included in the information distribution request is invalid, the determining unit 3 deletes the record (see Table 9) in the user location information DB 13 created in response to the information distribution request.

When the speaker ID included in the information distribution request is valid, the distribution control unit 4 distributes the distribution information according to the information distribution request to the terminal 30. In the case of the example of Table 11, the distribution information is gift information. The gift information indicates gifts to be provided to the user of the terminal 30.

The configuration of the speaker 20 will be explained next.

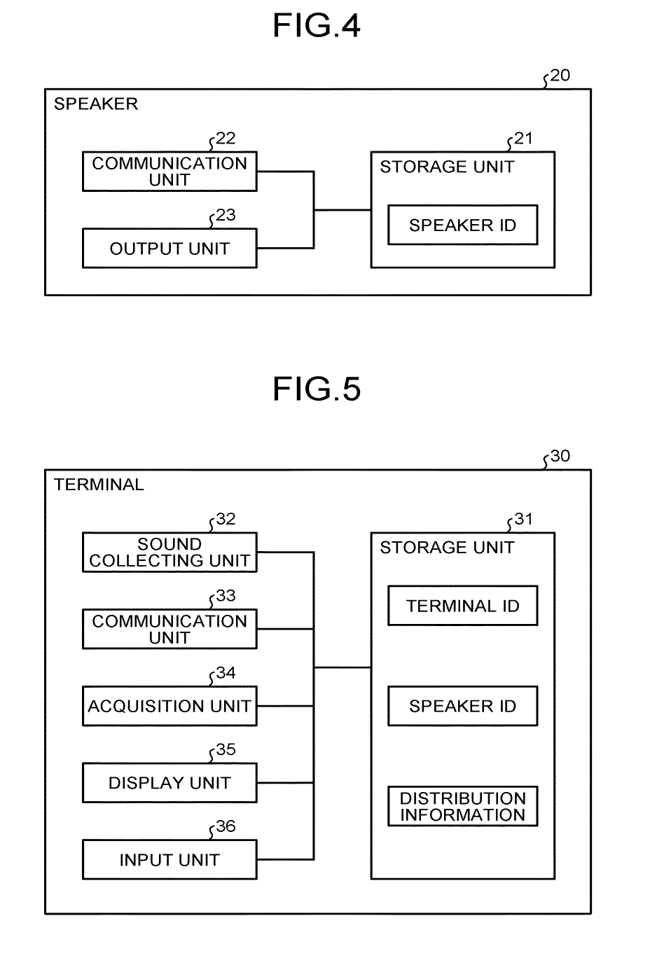

FIG. 4 is a diagram of a configuration example of the speaker 20 according to the embodiment. The speaker 20 according to the embodiment includes a storage unit 21, a communication unit 22, and an output unit 23. The storage unit 21 stores therein a speaker ID for identifying the speaker 20. The communication unit 22 stores the speaker ID in the storage unit 21 when receiving the speaker ID from the information distribution apparatus 10. The communication unit 22 periodically receives the speaker ID from the information distribution apparatus 10, and updates the speaker ID stored in the storage unit 21 with the received speaker ID. The output unit 23 reads the speaker ID from the storage unit 21 and outputs the sound wave including the speaker ID.

The configuration of the terminal 30 will be explained next.

FIG. 5 is a diagram of a configuration example of the terminal 30 according to the embodiment. The terminal 30 according to the embodiment includes a storage unit 31, a sound collecting unit 32, a communication unit 33, an acquisition unit 34, a display unit 35, and an input unit 36.

The storage unit 31 stores therein the terminal ID, speaker ID, and distribution information. The terminal ID is identification information for identifying the terminal 30. The speaker ID is a speaker ID included in the sound wave collected by the sound collecting unit 32. The distribution information is received from the information distribution apparatus 10 through the communication unit 33.

The sound collecting unit 32 acquires, when collecting the sound wave output from the speaker 20, the speaker ID included in the sound wave. The sound collecting unit 32 stores the speaker ID in the storage unit 31.

When the sound wave is collected by the sound collecting unit 32, the communication unit 33 reads the terminal ID and the speaker ID included in the sound wave from the storage unit 31. The communication unit 33 transmits the information distribution request including the terminal ID and the speaker ID to the information distribution apparatus 10.

When receiving the distribution information from the information distribution apparatus 10, the communication unit 33 stores the distribution information in the storage unit 31.

Moreover, when receiving a GPS information acquisition request from the information distribution apparatus 10, the communication unit 33 inputs the GPS information acquisition request to the acquisition unit 34. When receiving GPS Information indicating the location of the terminal 30 from the acquisition unit 34, the communication unit 33 transmits the GPS Information, as a response to the GPS information acquisition request, to the information distribution apparatus 10.

When receiving the GPS information acquisition request from the communication unit 33, the acquisition unit 34 acquires GPS Information indicating the location of the terminal 30. The acquisition unit 34 inputs the GPS Information to the communication unit 33 and transmits the GPS Information to the information distribution apparatus 10 through the communication unit 33.

When the communication unit 33 receives the distribution information from the information distribution apparatus 10, the display unit 35 displays the distribution information.

The input unit 36 receives an operation input of the user operating the terminal 30.

An information distribution method according to the embodiment will be explained next.

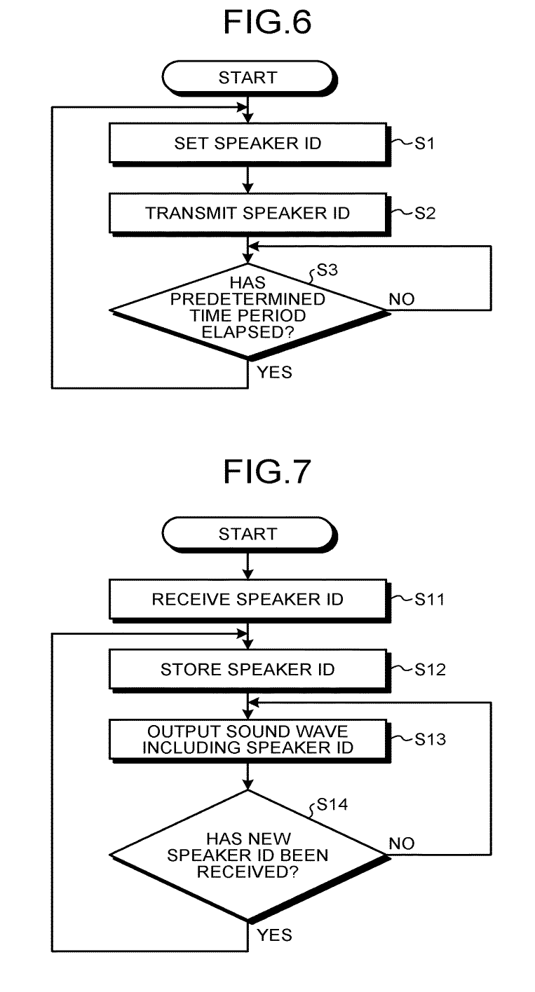

FIG. 6 is a flowchart of an example of how the information distribution apparatus 10 according to the embodiment transmits the speaker ID. First of all, the setting unit 1 creates the speaker information DB 12, and thereby sets a speaker ID for identifying the speaker 20 (Step S1). Then, the communication unit 2 transmits the speaker ID in the speaker information DB 12 to the speaker (Step S2). It is determined whether a predetermined time period (e.g., 1 hour) has elapsed since the setting unit 1 sets the speaker ID (Step S3). When a predetermined time period has not elapsed (No at Step S3), the setting unit 1 waits until the predetermined time period elapses. When a predetermined time period has elapsed (Yes at Step S3), the process returns to Step S1, and the speaker ID of the speaker 20 is updated with a different speaker ID. Specifically, the setting unit 1 adds a column of Speaker ID to the record in the speaker information DB 12 and sets the speaker ID in the added column of Speaker ID, thus updating the speaker ID of the speaker 20 with the different speaker ID.

FIG. 7 is a flowchart of an example of how the speaker 20 according to the embodiment outputs a sound wave. First of all, the communication unit 22 receives the speaker ID from the information distribution apparatus 10 (Step S11). Then, the communication unit 22 stores the speaker ID in the storage unit 21 (Step S12). The output unit 23 reads the speaker ID from the storage unit 21 and outputs the sound wave including the speaker ID (Step S13). It is determined whether the communication unit 22 has received a new speaker ID, from the information distribution apparatus (Step S14).

When a new speaker ID has not been received (No at Step S14), the process returns to Step S13, and the output of the sound wave including the speaker ID stored in the storage unit 21 is continued.

When a new speaker ID has been received (Yes at Step S14), the process returns to Step S12, and the communication unit 22 updates the speaker ID stored in the storage unit 21 with the newly received speaker ID. The output unit 25 then outputs the sound wave including the updated speaker ID (Step S13).

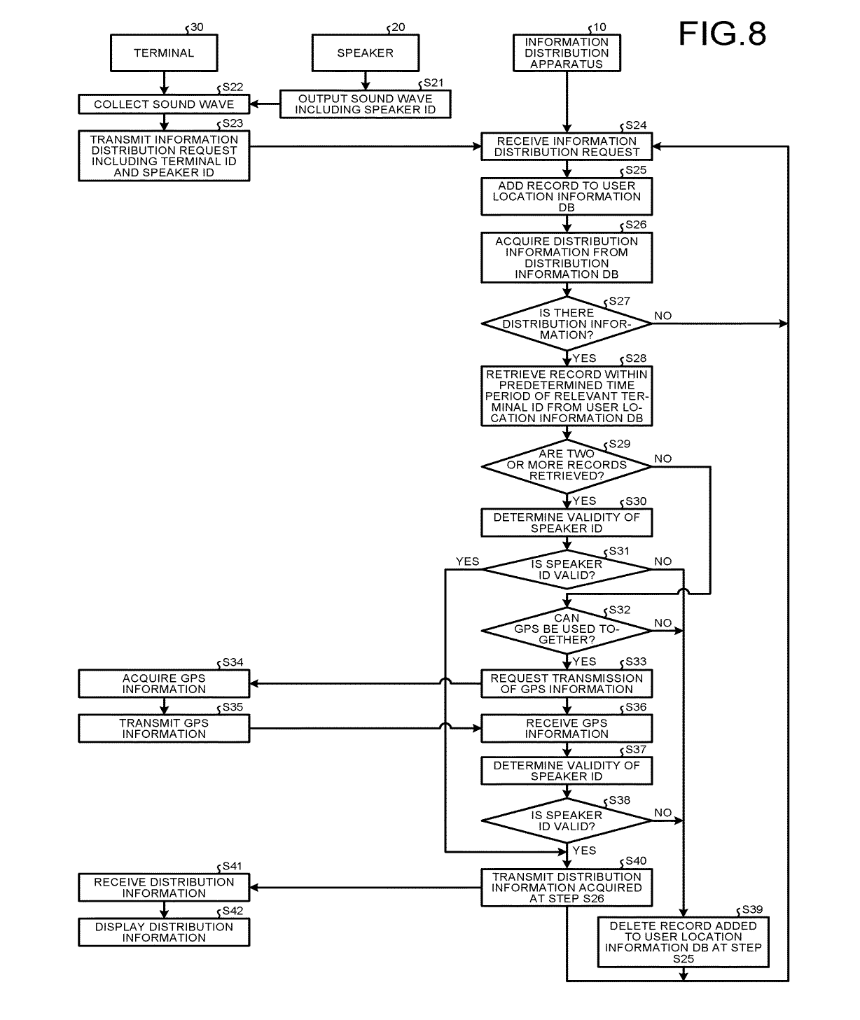

FIG. 8 is a sequence diagram of an example of an information distribution method according to the embodiment. First of all, the speaker 20 outputs the sound wave including the speaker ID (Step S21).

Then, the terminal 30 collects the sound wave from the speaker 20 (Step S22). The terminal 30 transmits the information distribution request including the terminal ID for identifying the terminal 30 itself and the speaker ID included in the sound wave collected at Step S22 to the information distribution apparatus 10 (Step S23).

The information distribution apparatus 10 receives the information distribution request from the terminal 30 (Step S24).

The information distribution apparatus 10 adds the record to the user location information DB 13 (Step S25). Specifically, the determining unit 3 sets the terminal ID and the speaker ID received from the communication unit 2 as Terminal ID and Speaker ID of the record to be added to the user location information DB 13. The determining unit 3 also sets the current time, which is a time at which the information distribution apparatus 10 receives the information distribution request, as Receipt Time of the record to be added to the user location information DB 13. The determining unit 3 searches a column of Speaker ID in the speaker information DB 12 using the speaker ID received from the communication unit 2 as a search key. When there is a plurality of columns of Speaker ID in the speaker information DB 12, the determining unit 3 searches a column of Speaker ID whose set time is the latest. The determining unit 3 sets the area, the facility, the facility number, and the location of the retrieved record in Area, Facility, Facility Number, and Location of the record to be added to the user location information DB 13.

The information distribution apparatus 10 acquires distribution information from the distribution information DB 14 (Step S26). Specifically, the distribution control unit 4 searches the speaker information DB 12 using the speaker ID included in the information distribution request as a search key. The distribution control unit 4 then acquires the area, the facility, the facility number, and the location from the retrieved record. The distribution control unit 4 searches the distribution information DB 14 using the area, the facility, the facility number, and the location as search keys. Then, the distribution control unit 4 acquires the distribution information from the retrieved record.

When there is no distribution information (No at Step S27), the process returns to Step S24, and the information distribution apparatus 10 waits for reception of a new information distribution request.

When there is distribution information (Yes at Step S27), the information distribution apparatus 10 retrieves information within a predetermined time period of the corresponding terminal ID from the user location information DB 13 (Step S28). Specifically, among the records of the user location information DB 13 including the terminal ID received from the communication unit 2, the determining unit 3 retrieves a record in which a value of Receipt time is within a predetermined time period (e.g., 10 minutes) before the current time.

When two or more records are retrieved (Yes at Step S29), the information distribution apparatus 10 determines the validity of the speaker ID included in the information distribution request (Step S30). Specifically, the determining unit 3 determines that the speaker ID included in the information distribution request is the valid speaker ID when a distance between the location of the speaker 20 identified from the speaker ID included in the information distribution request and the location of another speaker 20 identified from a speaker ID included in another information distribution request received within the predetermined time period (e.g., 10 minutes) before a receipt time, at which the information distribution request is received, is equal to or less than the threshold (e.g., 500 m).

When the speaker ID is invalid (No at Step S31), the information distribution apparatus 10 deletes the record added to the user location information DB 13 at the process of Step S25 (Step S39). The process of the information distribution apparatus 10 then returns to Step S24, and the information distribution apparatus 10 waits for reception of a new information distribution request.

When the speaker ID is valid (Yes at Step S31), the communication unit 2 transmits the distribution information acquired at Step S26 to the terminal 30 (Step S40). The process of the information distribution apparatus 10 then returns to Step S24, and the information distribution apparatus 10 waits for reception of a new information distribution request. The terminal 30 receives the distribution information from the information distribution apparatus 10 (Step S41). The terminal 30 then displays the distribution information received at Step S41 (Step S42).

When two or more records are not retrieved (No at Step S29), the information distribution apparatus 10 determines whether GPS can be used together with a record to identify the location of the terminal 30 (Step S32). Specifically, the determining unit 3 retrieves the speaker information DB 12 using the speaker ID included in the information distribution request as a search key. The determining unit 3 then acquires the area, the facility, the facility number, and the location from the retrieved record. The determining unit 3 searches the distribution information DB 14 using the area, the facility, the facility number, and the location as search keys. The determining unit 3 refers to the value of a combination with GPS column in the retrieved record to determine whether GPS can be used together.

When GPS cannot be used together (No at Step S32), the information distribution apparatus 10 deletes the record added to the user location information DB 13 at the process of Step S25 (Step S39). The process of the information distribution apparatus 10 then returns to Step S24, and the information distribution apparatus 10 waits for reception of a new information distribution request.

When GPS can be used together (Yes at Step S32), the communication unit 2 transmits a GPS information acquisition request to the terminal 30 (Step S33). When receiving the GPS information acquisition request from the information distribution apparatus 10, the terminal 30 acquires GPS information indicating the location information of the terminal 30 itself (Step S34). The terminal 30 then transmits the GPS information acquired at Step S34 to the information distribution apparatus 10 (Step S35). The information distribution apparatus 10 receives the GPS information from the terminal 30 (Step S36).

The information distribution apparatus 10 determines the validity of the speaker ID included in the information distribution request (Step S37). Specifically, the determining unit 3 determines that the speaker ID included in the information distribution request is the valid speaker ID when a distance is equal to or less than the threshold (e.g., 500 m), the distance being between the location indicated by the GPS information transmitted from the terminal 30 and the location indicated by the GPS information in a GPS information column of the record in the distribution information DB 14.

When the speaker ID is invalid (No at Step S38), the information distribution apparatus 10 deletes the record added to the user location information DB 13 at the process of Step S25 (Step S39). The process of the information distribution apparatus 10 then returns to Step S24.

When the speaker ID is valid (Yes at Step S38), the communication unit 2 transmits the distribution information acquired at Step S26 to the terminal 30 (Step S40). The process of the information distribution apparatus 10 then returns to Step S24. The terminal 30 receives the distribution information from the information distribution apparatus 10 (Step S41). The terminal 30 displays the distribution information received at Step S41 (Step S42).

Finally, an example of a hardware configuration of the information distribution apparatus 10 according to the embodiment will be explained below.

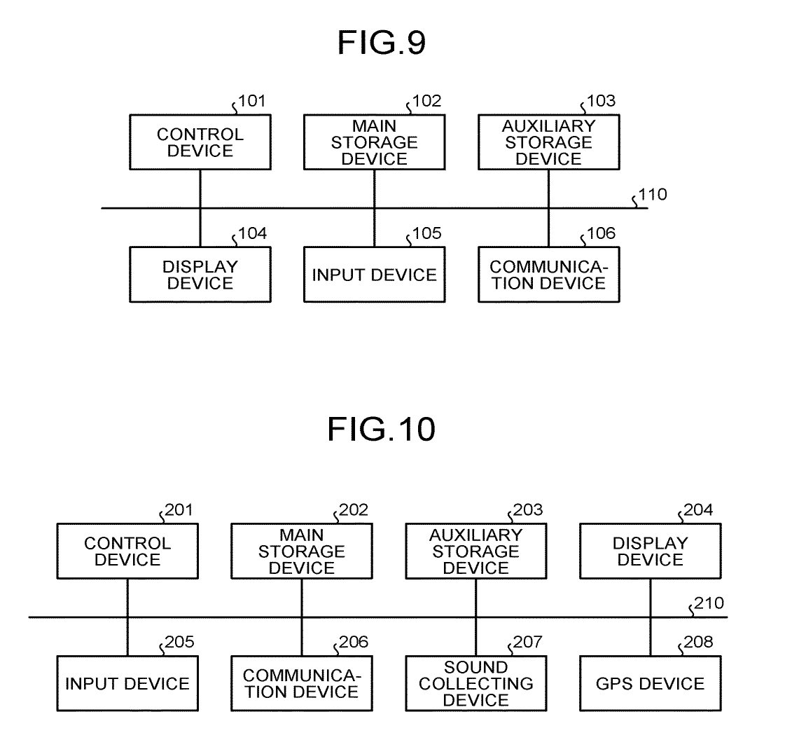

FIG. 9 is a diagram of an example of the hardware configuration of the information distribution apparatus 10 according to the embodiment. The information distribution apparatus 10 is, for example, a personal computer and a server device.

The information distribution apparatus 10 according to the embodiment includes a control device 101, a main storage device 102, an auxiliary storage device 103, a display device 104, an input device 105, and a communication device 106. The control device 101, the main storage device 102, the auxiliary storage device 103, the display device 104, the input device 105, and the communication device 106 are connected to each other through a bus 110.

The control device 101 executes a program loaded from the auxiliary storage device 103 into the main storage device 102. The main storage device 102 is a memory such as a read-only memory (ROM) and a random access memory (RAM). The auxiliary storage device 103 is a hard disk drive (HDD), a memory card, and the like. The storage unit 11 of FIG. 2 corresponds to the main storage device 102 and the auxiliary storage device 103.

The display device 104 displays, for example, a status of the information distribution apparatus 10. The display device 104 is, for example, a liquid crystal display. The input device 105 is an interface for operating the information distribution apparatus 10. The input device 105 includes, for example, a keyboard, a mouse, and a touch panel having both an input function and a display function. The communication device 106 is an interface for communicating with other devices.

Programs to be executed by the information distribution apparatus 10 according to the embodiment are recorded in a computer-readable recording medium such as a compact disk read only memory (CD-ROM), a memory card, a compact disk recordable (CD-R), and a digital versatile disk (DVD) in an installable or executable file format to be provided as a computer program product.

Moreover, the programs to be executed by the information distribution apparatus 10 according to the embodiment may be configured to be provided by being stored on a computer connected to a network such as the Internet and being downloaded through the network. The programs executed by the information distribution apparatus 10 according to the embodiment may be configured to be provided through the network such as the Internet without being downloaded.

The programs to be executed by the information distribution apparatus 10 according to the embodiment may be configured to be provided by being previously incorporated in a ROM or the like.

The programs to be executed by the information distribution apparatus 10 according to the embodiment have a module configuration including function blocks in FIG. 2 (the setting unit 1, the communication unit 2 (excluding hardware such as a communication I/F), the determining unit 3, and the distribution control unit 4). The function blocks, as actual hardware, are loaded on the main storage device 102 by the control device 101 that reads the programs from the storage medium and executes them. That is, the function blocks are generated on the main storage device 102. Part or all of the function blocks in FIG. 2 may be implemented by hardware such as an integrated circuit (IC) instead of being implemented by software.

FIG. 10 is a diagram of an example of a hardware configuration of the terminal 30 according to the embodiment. Examples of the terminal 30 include, but are not limited to, a smartphone, a tablet type terminal, and a notebook computer.

The terminal 30 according to the embodiment includes a control device 201, a main storage device 202, an auxiliary storage device 203, a display device 204, an input device 205, a communication device 206, a sound collecting device 207, and a GPS device 208. The control device 201, the main storage device 202, the auxiliary storage device 203, the display device 204, the input device 205, the communication device 206, the sound collecting device 207, and the GPS device 208 are connected to each other through a bus 210.

The control device 201 executes a program loaded from the auxiliary storage device 203 into the main storage device 202. The main storage device 202 is a memory such as ROM and RAM. The auxiliary storage device 203 is a HDD, a memory card, and the like. The storage unit 31 of FIG. 5 corresponds to the main storage device 202 and the auxiliary storage device 203.

The display device 204 displays, for example, a status of the terminal 30. The display device 204 is, for example, a liquid crystal display. The display unit 35 of FIG. 5 corresponds to the display device 204.

The input device 205 is an interface for operating the terminal 30. The input device 205 includes, for example, a keyboard, a mouse, and a touch panel having both an input function and a display function. The input unit 36 of FIG. 5 corresponds to the input device 205.

The communication device 206 is an interface for communicating with other devices. The communication unit 33 of FIG. 5 corresponds to the communication device 206.

The sound collecting device 207 collects ambient sounds of the terminal 30. The sound collecting device 207 is, for example, a microphone. The sound collecting unit 32 of FIG. 5 corresponds to the sound collecting device 207.

The GPS device 208 receives signals from a plurality of GPS satellites and acquires GPS Information indicating a location of the terminal 30. The acquisition unit 34 of FIG. 5 corresponds to the GPS device 208.

As explained above, the information distribution system 100 according to the embodiment includes the information distribution apparatus 10 that distributes distribution information to the terminal 30, the speaker 20 (which corresponds to the sound wave generator) that outputs a sound wave including the speaker ID (which corresponds to the first identification information), and the terminal that transmits the information distribution request including the terminal ID (which corresponds to the second identification information) for identifying the terminal 30 and the speaker ID included in the sound wave to the information distribution apparatus 10.

The storage unit 11 of the information distribution apparatus 10 stores the speaker ID and the distribution information in association with each other using the speaker information DB 12 and the distribution information DB 14. The communication unit 2 receives the information distribution request from the terminal 30. The determining unit 3 determines that the speaker ID included in an information distribution request is the valid speaker ID when a distance is equal to or less than the threshold (e.g., 500 m), the distance being between the location of the speaker 20 identified from the speaker ID included in the information distribution request and the location of another speaker 20 identified from another speaker ID included in another information distribution request received within a predetermined time period (e.g., 10 minutes) before a receipt time (which corresponds to a first time), at which the information distribution request is received. When the speaker ID is valid, the distribution control unit 4 distributes the distribution information associated with the speaker ID to the terminal 30 which has transmitted the information distribution request.

With this configuration, according to the information distribution system 100, it is possible to more easily determine the validity of the speaker ID transmitted from the terminal 30 as the location identification information for identifying the location of the user of the terminal 30. For example, by implementing the information distribution system 100 according to the embodiment, the validity of the speaker ID transmitted from the terminal 30 can be determined more easily without encryption and decryption of the speaker ID.

According to the present invention, it is possible to more easily determine the validity of the location identification information transmitted from a terminal.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information distribution system comprising:
an information distribution apparatus;
a sound wave generator; and
a terminal, wherein
the sound wave generator comprises
an output unit configured to output a sound wave including first identification information for identifying the sound wave generator,
the terminal comprises:
a sound collecting unit configured to collect the sound wave output from the sound wave generator; and
a first communication unit configured to transmit an information distribution request that includes second identification information for identifying the terminal and the first identification information included in the sound wave to the information distribution apparatus, and
the information distribution apparatus comprises:
a second communication unit configured to receive the information distribution request from the terminal;
a determining unit configured to, when a distance between a location of the sound wave generator identified from the first identification information included in a first information distribution request received at a first time and a location of the sound wave generator identified from the first identification information included in a second information distribution request received at a second time prior to the first time is equal to or less than a threshold, determine that the second identification information included in the first information distribution request is valid; and
a distribution control unit configured to, when the first identification information is valid, distribute distribution information associated with the first identification information to the terminal which has transmitted the information distribution request.

2. The information distribution system according to claim 1, wherein the second time is within a predetermined time period before the first time.

3. The information distribution system according to claim 1, wherein
the sound wave generator further comprises a third communication unit configured to periodically receives the first identification information from the information distribution apparatus, and
the output unit outputs a sound wave including the first identification information updated with the first identification information periodically received from the information distribution apparatus.

4. The information distribution system according to claim 1, wherein
the terminal further comprises an acquisition unit configured to acquire location information of the terminal,
when receiving an acquisition request of the location information of the terminal from the information distribution apparatus, the first communication unit transmits the location information of the terminal to the information distribution apparatus, and
when there is no second information distribution request received at the second time prior to the first time, if a distance between the location of the terminal indicated by the location information of the terminal and the location of the sound wave generator indicated by the location information of the sound wave generator associated with the first identification information included in the first information distribution request is equal to or less than a threshold, the determining unit determines that the first identification information included in the first information distribution request is valid.

5. The information distribution system according to claim 4, wherein the acquisition unit acquires the location information using Global Positioning System.

6. An information distribution apparatus that is connected to
a sound wave generator that outputs a sound wave including first identification information for identifying the sound wave generator, and
a terminal that transmits an information distribution request that includes second identification information for identifying the terminal and the first identification information included in the sound wave to the information distribution apparatus,
the information distribution apparatus comprising:
a communication unit configured to receive the information distribution request from the terminal;
a determining unit configured to, when a distance between a location of the sound wave generator identified from the first identification information included in a first information distribution request received at a first time and a location of the sound wave generator identified from the first identification information included in a second information distribution request received at a second time prior to the first time is equal to or less than a threshold, determine that the second identification information included in the first information distribution request is valid; and
a distribution control unit configured to, when the first identification information is valid, distribute distribution information associated with the first identification information to the terminal which has transmitted the information distribution request.

7. An information distribution method performed in an information distribution apparatus that is connected to
a sound wave generator that outputs a sound wave including first identification information for identifying the sound wave generator, and
a terminal that transmits an information distribution request that includes second identification information for identifying the terminal and the first identification information included in the sound wave to the information distribution apparatus,
the method comprising:
receiving the information distribution request from the terminal;
determining that, when a distance between a location of the sound wave generator identified from the first identification information included in a first information distribution request received at a first time and a location of the sound wave generator identified from the first identification information included in a second information distribution request received at a second time prior to the first time is equal to or less than a threshold, the second identification information included in the first information distribution request is valid; and
distributing, when the first identification information is valid, distribution information associated with the first identification information to the terminal which has transmitted the information distribution request.
